(19) United States
(12) Patent Application Publication
(10) Pub. No.: US 2002/0161975 A1
(43) Pub. Date: Oct. 31, 2002

(54) Cache to cache copying of clean data

(76) Inventor: Daniel V. Zilavy, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/792,319

(22) Filed: Feb. 23, 2001

(51) Int. Cl. G06F 12/08

(52) U.S. Cl. 711/120; 711/144; 711/145; 711/146

(57) ABSTRACT

A data storage apparatus comprises a plurality of computer processors, each having an internal memory, and a plurality of unshared “clean data present” indicators connected to the plurality of computer processors. Each of the plurality of unshared “clean data present” indicators corresponds to one of the plurality of computer processors. Each of the plurality of computer processors is adapted to assert its corresponding unshared “clean data present” indicator when requested data is contained in its internal memory in an unmodified state.

### FIELD OF THE INVENTION

This invention relates to copying of clean data between cache memories and more particularly to cache to cache copying of clean data in bus architectures having a single shared clean cache hit signal.

### BACKGROUND

As computer processors and software have become faster, they have also become much more complex and memory intensive. Today's extremely fast computer processors can handle enormous amounts of data at incredible speeds. A great deal of effort has consequently been focused on developing faster memory chips and efficient memory control circuitry. However, the main memory (e.g., random access memory, or RAM) of a computer is not incorporated in the processor, but is independently packaged and connected to the processor by electrical signals including address and data buses. A memory controller is often required to buffer memory accesses between the processor and the main memory, as well as to refresh the data in the main memory. There are a number of factors which cause a delay, or latency, each time the processor accesses data in the main memory, such as the relatively low speed of the main memory, the delay caused by the memory controller, the transfer time of the electrical signals between the processor and the main memory, and delays inherent in the electrical buses between the processor and the main memory.

To reduce the effect of this memory access latency, small cache memories are included in most modern computer processors. A cache memory is a memory located in the same package as the processor in which frequently used data values are duplicated for rapid access. Copies of frequently accessed data items are stored in the cache along with the addresses of the original data items in external RAM. When the processor references an address in the main memory, the cache is checked to see whether it holds that address. If it does hold the address, the data is returned to the processor from the cache; otherwise, the processor must read the data from the main memory. Accessing data in the cache memory is much faster than accessing the data in the main memory since the cache memory is faster and is packaged with the processor, reducing the use of the external memory via slower buses.

The main memory of a computer, typically RAM, will hereinafter be referred to simply as the ‘memory’, while the cache memory will be referred to as the ‘cache’.

Despite the benefits of caches and faster external memories, memory access latency problems have intensified in some ways. For example, the tendency to include multiple computer processors in a single computer system with a single memory increases the memory access latency, since multiple processors must share the memory. Also, although each processor typically includes its own cache, the data duplicated in each cache benefits only its own processor, and no clean (unmodified) data is shared between caches.

As computer systems have become more complex and networks have become more prevalent, remote memories are also increasing memory access latency problems. For example, in sophisticated computer system infrastructures, the memory may not be located near the processors across a single bus with a single memory controller. If the memory is remote, processors may have to access it through several memory controllers across network devices such as an optical link.

Consequently, a need exists for an apparatus for providing computer processors with rapid access to data. A further need exists for an apparatus for copying data from one processor's cache to another's in a computer system. A further need exists for an apparatus for cache to cache copying of clean data.

### SUMMARY

To assist in achieving the aforementioned needs, the inventor has devised a system for copying clean data between computer processor caches in a computer system. Thus, unmodified data can be rapidly shared between computer processor caches without requiring a slower external memory read.

The invention may comprise a data storage apparatus having a plurality of computer processors, each having an internal memory, with a plurality of unshared “clean data present” indicators connected to the plurality of computer processors. Each of the plurality of unshared “clean data present” indicators corresponds to one of the plurality of computer processors. Each of the plurality of computer processors is adapted to assert its corresponding unshared “clean data present” indicator when requested data is contained in its internal memory in an unmodified state.

The invention may also comprise a method of sharing data in a computer system. The method comprises providing the computer system which includes a plurality of computer processors, each having an internal memory, and an external memory connected to the plurality of computer processors. The computer system also comprises a plurality of unshared “clean data present” indicators connected to the plurality of computer processors, each of the plurality of unshared “clean data present” indicators corresponding to one of the plurality of computer processors. The computer system also comprises a shared “modified data present” indicator connected to the plurality of computer processors and to the external memory. The computer system also comprises a data bus and an address bus connected to the plurality of computer processors and to the external memory. The method also includes sharing data in the computer system according to signals placed on the plurality of unshared “clean data present” indicators, the shared “modified data present” indicator, and the address bus.

The invention may also comprise a computer system having a plurality of computer processors, each having an internal cache memory, the system also having an external memory connected to the plurality of computer processors, and unshared “clean data present” indicator means connected to the plurality of computer processors.

### BRIEF DESCRIPTION OF THE DRAWING

Illustrative and presently preferred embodiments of the invention are shown in the accompanying drawing, in which:

FIG. 1 is a block diagram of a computer system having a bus architecture with a single shared clean cache hit signal;

FIG. 2 is a flow chart illustrating when a processor in the computer system of FIG. 1 asserts its shared “modified data present” signal and its unshared “clean data present” signal;

FIG. 3 is a flow chart illustrating a data read operation in the computer system of FIG. 1;

FIG. 4 is a block diagram of a computer system having a bus architecture with multiple unshared clean cache hit signals;

FIG. 5 is a flow chart illustrating when a processor in the computer system of FIG. 4 asserts its shared “modified data present” signal and its unshared “clean data present” signal; and

FIG. 6 is a flow chart illustrating a data read operation in the computer system of FIG. 4.

### DESCRIPTION OF THE PREFERRED EMBODIMENT

The drawing and description, in general, disclose a data storage apparatus having a plurality of computer processors, each having an internal memory, with a plurality of unshared “clean data present” indicators connected to the plurality of computer processors. Each of the plurality of unshared “clean data present” indicators corresponds to one of the plurality of computer processors. Each of the plurality of computer processors is adapted to assert its corresponding unshared “clean data present” indicator when requested data is contained in its internal memory in an unmodified state.

The drawing and description also disclose a method of sharing data in a computer system. The method comprises providing the computer system which includes a plurality of computer processors, each having an internal memory and an external memory connected to the plurality of computer processors. The computer system also comprises a plurality of unshared “clean data present” indicators connected to the plurality of computer processors, each of the plurality of unshared “clean data present” indicators corresponding to one of the plurality of computer processors. The computer system also comprises a shared “modified data present” indicator connected to the plurality of computer processors and to the external memory. The computer system also comprises a data bus and an address bus connected to the plurality of computer processors and to the external memory. The method also includes sharing data in the computer system according to signals placed on the plurality of unshared “clean data present” indicators, the shared “modified data present” indicator, and the address bus.

The drawing and description also disclose a computer system having a plurality of computer processors, each having an internal cache memory, the system also having an external memory connected to the plurality of computer processors, and unshared “clean data present” indicator means connected to the plurality of computer processors.

In a preferred exemplary embodiment, sideband signals are added between multiple computer processors in a computer system having a bus architecture with a single shared clean cache hit signal. The sideband signals enable clean data to be copied directly between processor caches in the system, rather than from the system memory. Bus architectures having a single shared clean cache hit signal are well known and are used, for example, with computer processors such as the Pentium® Pro and the Pentium® II, available from the Intel Corporation of Santa Clara, Calif. A significant advantage of the use of sideband signals to enable cache to cache copying of clean data is that processors in the system can share cached data without reading the data from the external memory. This can greatly speed data retrieval in systems having a large latency in the external memory.

The term signal, as used herein, refers both to physical electrical conductors as well as to the information carried by the conductors.

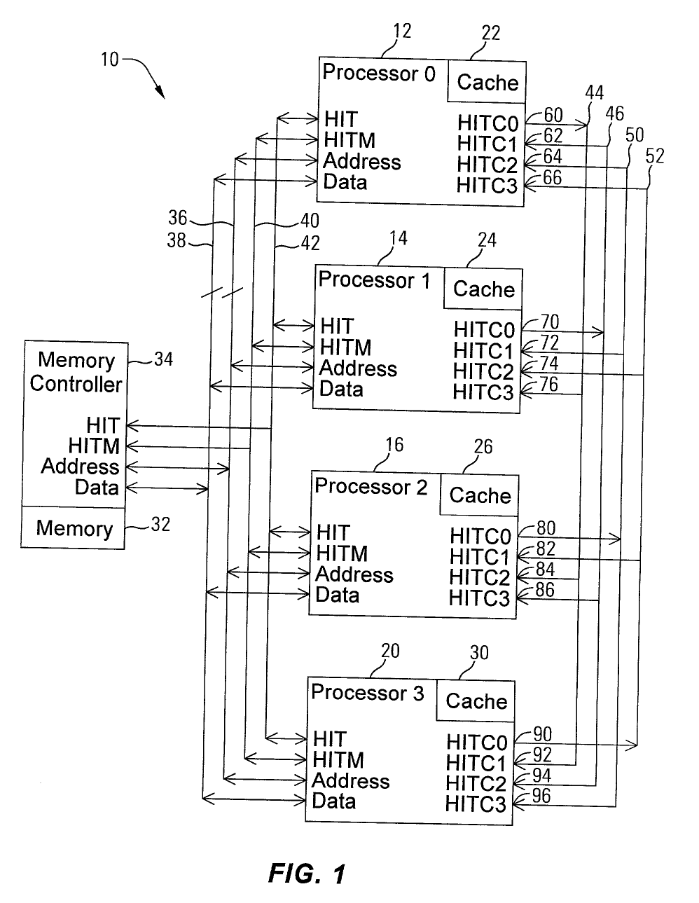

Referring now to FIG. 1, the first preferred exemplary embodiment of cache to cache copying of clean data will be described in more detail. The computer system 10 in this example includes four computer processors 12, 14, 16, and 20. Alternatively, the computer system 10 may have any number of computer processors. Each of the processors 12-20 includes an internal memory cache 22, 24, 26, and 30, respectively. An external memory 32 and memory controller 34 are connected to the processors 12-20 by an address bus 36 and a data bus 38. The memory controller 34 is associated with the external memory 32 to perform control functions such as interpreting and responding to read and write commands, error correction, interleaving, mapping virtual addresses to physical addresses, refreshing the memory 32, etc. Memory and memory controllers are available in a variety of types and configurations, both separate and integrated. For example, some external memories have complex control circuitry included which perform all required control functions without a separate memory controller. The present invention for cache to cache copying of clean data may be used with any type of external memory and should not be viewed as limited to use with any particular type of external memory and memory controller. In fact, cache to cache copying of clean data may be applied to a computer system in which all data storage is contained within the computer processors, rather than in an external memory.

Data in the computer system 10 is commonly held, that is, only one version of the data in the computer system 10 is maintained, whether the data is stored in the external memory 32, in the processor caches 22-30, or in some combination of these memory devices. Indeed, copies of commonly used data in this multiprocessor computer system 10 are often found simultaneously in the external memory 32 and in several of the processor caches 22-30. It is important that only one processor 12-20 modify data at any given time to avoid having multiple versions of the same data. A shared “modified data present” signal, or HITM signal 40, is therefore connected to each of the processors 12-20 and to the memory controller 34 (or to the external memory 32, depending upon the external memory configuration, as discussed above.) The HITM signal 40 enables a processor (e.g., 12 ) to indicate to the other processors 14-20 that it has modified its copy of data in its cache 22. If another processor 14-20 subsequently requests a copy of the data, it will be retrieved in its modified state from the processor 12 which modified the data.

All signals on the bus in the preferred embodiment are open-drain, active low signals, including the HITM signal 40. Therefore, when asserted the signals are in the electrically low state, and when deasserted they are in the electrically high state. The signals on the bus are all pulled up to the electrically high deasserted state. The signals may be asserted by multiple devices on the bus simultaneously by pulling them down to the electrically low state. Alternatively, the signals in the bus may have any desired structure for passing information between devices on the bus. For example, the bus may be a serial bus in which the various signals are transmitted as code words on a single conductor in serial fashion.

A shared “clean data present” signal, or HIT signal 42, is connected to each of the processors 12-20 and to the memory controller 34. The HIT signal 42 indicates when one or more of the processors 12-20 contain a clean, or unmodified, copy of requested data in their caches 22-30. The processors 12-20 assert the HIT signal 42 when they contain a copy of requested data that they have not modified since reading the data into their caches 22-30.

The address bus 36 is used to communicate the address of requested data, and the data bus 38 is used to transmit the requested data.

In operation, the address and data buses 36 and 38 and the HIT and HITM signals 42 and 40 allow processors to coordinate transfers of data throughout the computer system 10. A first example will now be given which describes the behavior of the computer system 10 having a shared “clean data present” signal 42 without the sideband signals which enable cache to cache copying of clean data, to be described hereinafter. In this first example, data is contained in the external memory 32 and in the caches 24 and 26 of processors 1 14 and 2 16 (both in clean form). Processor 0 12 needs a copy of the data, so it places the address of the data on the address bus 36. Processors 1 14 and 2 16 contain the requested data in their caches 24 and 26 in clean form, so they both assert the shared HIT signal 42, indicating that one or more processors 12-20 in the computer system 10 have clean copies of the requested data. Since the HITM signal 40 is not asserted, the data has not been modified and there is only one version of the data in the computer system 10. The memory controller 34 therefore copies the requested data from the memory 32 onto the data bus 38, and the requesting processor 0 12 copies the data from the data bus 38 into its cache 22. This example illustrates the disadvantage of the bus architecture having a shared “clean data present” signal 42 without the sideband signals to be discussed. Although the requested data was contained in clean form in the caches 24 and 26 of two processors 14 and 16, the slower memory had to source the data.

Note that data is requested by placing the address of the data on the address bus 36. In the preferred embodiment, the address placed on the address bus 36 corresponds to the data's location in the memory 32. Copies of the data in processor caches 22-30 are labeled with that address, even though their physical locations in the cache memories are different. However, cache to cache copying of clean data as disclosed herein is not limited to any particular scheme of addressing or requesting of data. Therefore, a broad description is given herein which may easily be applied to various bus configurations. Accordingly, the many details of bus architectures such as the different phases of memory operations (e.g., request, error, snoop, response, and data phases) will not be discussed in detail herein, although it may be helpful to note that cache to cache copying of clean data typically affects the snoop and data phases of read operations only.

In a second example, data is contained in the external memory 32 and in the cache 24 of processor 1 14. However, in this second example, processor 1 14 has modified the data after copying it into its cache 24 from the external memory 32. Processor 0 12 needs a copy of the data, so it places the address of the data on the address bus 36. Processor 1 14 asserts the HITM signal 40, indicating that it contains the requested data in modified form. Processor 1 14 then places the modified requested data onto the data bus 38, and processor 0 12 copies the modified data from the data bus 38 into its cache 22. The memory controller 34 also copies the modified data into the external memory 32, overwriting the previous copy of the data, so that a uniform version of the data exists throughout the computer system 10. (This copying of modified data over previous versions of the data in the memory 32 is referred to as an implicit writeback.) This second example applies to the computer system 10 in the first preferred exemplary embodiment whether or not the sideband signals are included, unlike the first example above.

Unshared “clean data present” sideband signals, or HITC signals (on conductors 44, 46, 50, and 52 ) are added to the computer system 10 to enable cache to cache copying of clean data. (The term “sideband” refers to the fact that the signals are not a part of the standard bus architecture in the preferred exemplary embodiment.) Each of the sideband signal conductors 44-52 are connected to every processor 12-20 in the computer system 10. Each sideband signal conductor (e.g., 44 ) is associated with only one processor (e.g., 12 ), and is asserted only by its associated processor 12. When data is requested, each processor 12-20 having a clean copy of the data in its cache 22-30 asserts its HITCO signal 60, 70, 80, or 90 (on conductors 44-52 ), along with the HITM signal 40. One of the processors 12-20 having a clean copy of the data then copies the clean data to the data bus 38, where it can be read by the requesting processor. The sideband HITC signals on conductors 44-52 enable cache to cache copying of clean data, reducing the frequency of memory reads from the external memory 32. This can greatly speed memory operations in the computer system 10, particularly when the external memory 32 has a large latency.

When multiple processors 12-20 contain clean copies of requested data, only one of them can source the requested data onto the data bus 38 or the multiple sources will conflict with one another. Therefore, the priority of each of the processors 12-20 having the clean requested data must be determined, and only the processor with the highest priority sources the data. This arbitration process may be performed in any desired manner. In the preferred exemplary embodiment, each of the four processors 12-20 always asserts its HITC0 signal 60, 70, 80, and 90 when it contains clean requested data. Each processor 12-20 can examine the input HITC1 ( 62, 72, 82, and 92 ), HITC2 ( 64, 74, 84, and 94 ), and HITC3 ( 66, 76, 86, and 96 ) signals to determine whether another processor having a higher priority than itself has a copy of the data. If not, it sources the requested data onto the data bus 38. (The HITCO signals 60, 70, 80, and 90 on the processors 12-20 are outputs, and the HITC1, HITC2, and HITC3 signals 62-66, 72-76, 82-86, and 92-96 are inputs.)

The processors 12-20 have an identification signal (not shown) wired into their sockets so that each is aware of its priority. Processor 3 20 has the highest priority and processor 0 12 has the lowest, as follows: processor 3 20>processor 2 16>processor 1 14>processor 0 12. Therefore processor 3 20 will source clean data regardless of whether any of the other processors 0-2 12-16 also contain a copy of the clean data. Processor 2 16 will source the clean data only if processor 3 20 does not have it. Processor 1 14 will source the clean data only if processors 2 and 3 16-20 do not have it. Processor 0 12 will source the clean data only if processors 1, 2 and 3 14-20 do not have it.

In this exemplary embodiment, the first HITC signal conductor 44 is associated with processor 0 12. It is connected to the HITC0 signal 60 on processor 0 12, and to the HITC3 signal 76 on processor 1 14, the HITC2 signal 84 on processor 2 16, and the HITC1 signal 92 on processor 3 20. The second HITC signal conductor 46 is associated with processor 1 14. It is connected to the HITC0 signal 70 on processor 1 14, the HITC1 signal 62 on processor 0 12, the HITC3 signal 86 on processor 2 16, and the HITC2 signal 94 on processor 3 20. The third HITC signal conductor 50 is associated with processor 2 16. It is connected to the HITC0 signal 80 on processor 2 16, the HITC2 signal 64 on processor 0 12, the HITC1 signal 72 on processor 1 14, and the HITC3 signal 96 on processor 3 20. The fourth HITC signal conductor 52 is associated with processor 3 20. It is connected to the HITC0 signal 90 on processor 3 20, the HITC3 signal 66 on processor 0 12, the HITC2 signal 74 on processor 1 14, and the HITC1 signal 82 on processor 2 16.

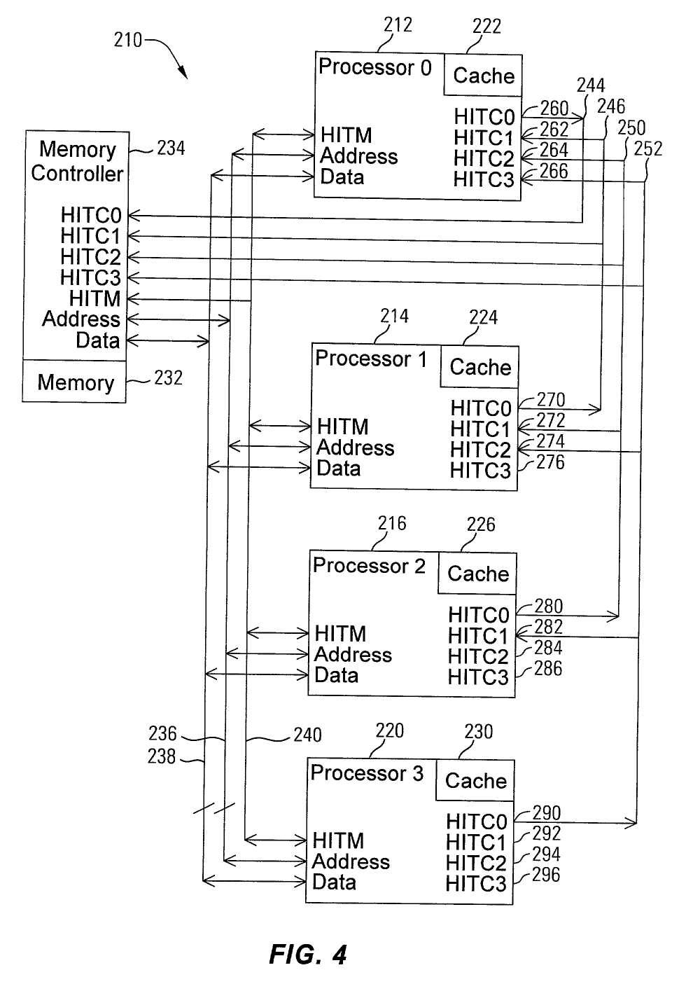

Since processor 3 20 has priority, it does not have to examine its HITC1, HITC2, or HITC3 signals 92, 94, and 96 before sourcing data to the data bus 38. Similarly, processor 2 16 does not have to examine its HITC2 or HITC3 signals 84 and 86, and processor 1 14 does not have to examine its HITC3 signal 76. Therefore, the HITC signal conductors may be left disconnected from these inputs if desired, as illustrated in FIG. 4, to be discussed hereinafter.

It should be noted that the processors 12-22 are preferably identical so that they are interchangeable. The identification signals (not shown) wired into the sockets and the sideband signal wiring provide the information needed by each processor to determine whether to source clean requested data onto the data bus 38.

As the arbitration scheme described above is purely exemplary, the circuitry needed in each processor to implement the arbitration scheme above will not be described herein. However, given the detailed description of the arbitration scheme above, one skilled in the art of processor design could easily add the simple hardware needed. For the arbitration scheme described above, a processor simply needs to determine its priority from the identification signal in the socket, and examine only the HITC signals from higher priority processors. In this four processor example, if the processor has the highest priority, it examines no HITC inputs. If the processor has the third highest priority, it examines its HITC1 input. If the processor has the second highest priority, it examines its HITC1 and HITC2 inputs. Finally, if the processor has the lowest priority, it examines all its HITC inputs. If any of the examined HITC inputs are asserted, the processor does not source the requested data, since it will be sourced by a higher priority processor.

The addition of sideband signals to an existing bus architecture having a shared “clean data present” signal requires the processors 12-20 to assert the HITM signal 40 anytime they assert their HITC signals 60, 70, 80, and 90. This prevents the memory controller 34 from attempting to source the clean data at the same time that one of the processors 12-20 is sourcing the clean data, thus preventing a bus conflict between the memory controller 34 and the processors 12-20. Since this first preferred exemplary embodiment is based upon a bus architecture having a shared “clean data present” signal, the memory controller 34 sources all clean requested data, as described in the first example above. Therefore, the processors must assert their HITM signals 60, 70, 80, and 90 before sourcing clean data, indicating to the memory controller 34 that a processor will be sourcing modified data (even though no modified data exists). This has the side effect of causing an implicit writeback, wherein the memory controller 34 copies the data from the data bus 38 into the memory 32. In this case, it is copying the same clean version of data over the existing data in the memory 32, leaving the data effectively unchanged in memory 32.

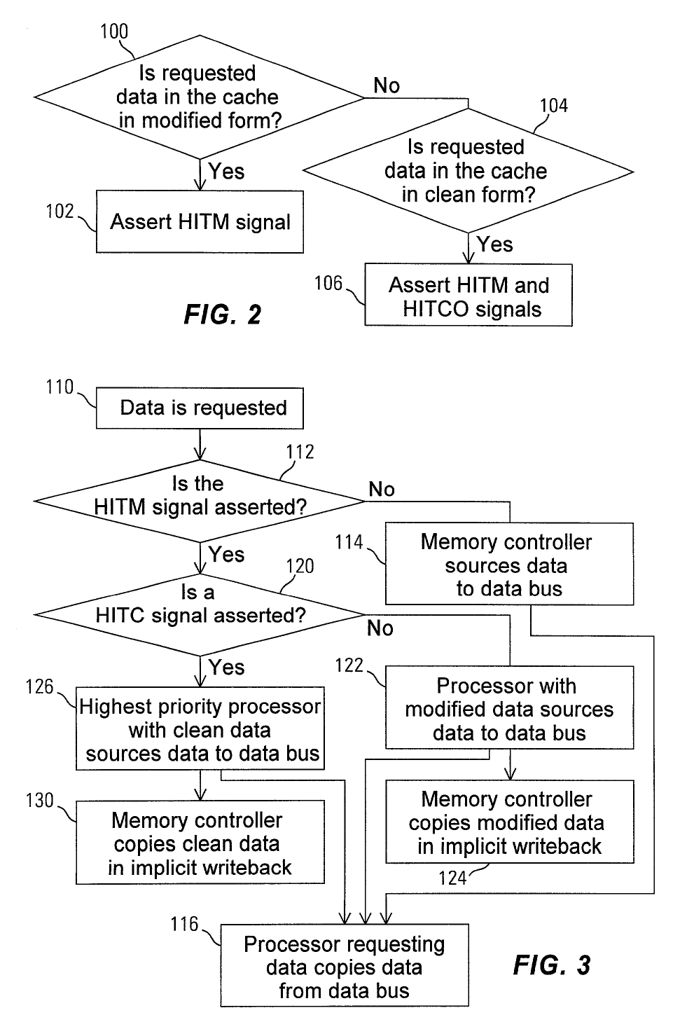

The HITM and HITC0 signal assertion process is illustrated in the flow chart of FIG. 2. This process is typically referred to as “snooping” and is performed during the “snoop” phase of a memory operation. When a device in the computer system 10 performs a read operation by placing an address on the address bus 36, each processor 12-20 snoops the address in its cache 22-30 and reports the results on the HIT, HITM, and HITC signals 40, 42, and 44-52. Thus, when each processor (e.g., 12 ) sees a request for data on the address bus 36, it examines its cache 22 for the requested data. If the requested data is stored there in modified form 100, the processor 12 asserts 102 the HITM 40 signal. If the requested data is stored there in clean form 104, the processor 12 asserts both the HITM 40 and HITC0 60 signals. As discussed above, the HITM signal 40 is asserted to prevent the memory controller 34 from sourcing the data, even though this causes an implicit writeback.

Typical computer processors include cache controllers (not shown), analogous to the memory controller 34, which perform many or all of the snooping functions.

The following snoop results table summarizes the effects on the computer system 10 of each possible snoop result.

| Transaction | | | | |
|---|---|---|---|---|
| Snooped | HITCx | HIT | HITM | Result |
| Memory Read | 0 | 0 | 0 | Cache miss. |
| | | | | Data sourced by the |
| | | | | memory controller. |
| | 0 | 0 | 1 | Hit on a dirty line. |
| | | | | Data sourced by the |
| | | | | processor with the |
| | | | | modified data. |
| | 0 | 1 | 0 | Illegal |
| | 0 | 1 | 1 | Snoop stall |
| | 1 | 0 | 0 | Illegal |
| | 1 | 0 | 1 | Hit on a clean line. |
| | | | | Data sourced by the |
| | | | | highest priority |
| | | | | processor having the |
| | | | | clean data. |
| | 1 | 1 | 0 | Illegal |
| | 1 | 1 | 1 | Snoop stall |
| Memory | 0 | X | X | Normal operation |
| Write | | | | |
| | 1 | X | X | Illegal |
| Memory Read | 0 | 0 | 0 | Cache miss. |
| and | | | | Data sourced by the |
| Invalidate | | | | memory controller. |
| | 0 | 0 | 1 | Hit on a dirty line. |
| | | | | Data sourced by the |
| | | | | processor with the |
| | | | | modified data. |
| | 0 | 1 | 0 | Illegal |
| | 0 | 1 | 1 | Snoop Stall |
| | 1 | 0 | 0 | Illegal |
| | 1 | 0 | 1 | Hit on a clean line. |
| | | | | Data sourced by the |
| | | | | highest priority |
| | | | | processor having the |
| | | | | clean data. |
| | 1 | 1 | 0 | Illegal |
| | 1 | 1 | 1 | Snoop Stall |
| Invalidate | 0 | X | X | Normal operation |
| | 1 | X | X | Illegal |

The table summarizes results for several types of transactions, including memory reads and writes, read and invalidate, and invalidate. The latter two transactions are performed by a processor which is about to modify data. Other processors in the computer system 10 which detect these types of transactions purge their clean copies of the data from their caches to prevent different versions of the data from existing in the system. Thus, if a processor actually has a modified copy of requested data, no other processor will have a copy of the data, clean or modified. (The read and invalidate and invalidate transactions indicate that the requesting processor will have the data in exclusive mode, rather than shared mode.)

In the first row in which no signals are asserted (memory read state 000), no processor has the requested data, either in clean or modified form, so the memory controller 34 sources the data. In memory read state 001, only the HITM signal is asserted and the processor having the modified requested data sources the data. Memory read state 010 is an illegal state, because if a processor has a clean copy of the requested data it will assert its HITC and the HITM signal. Memory read state 011 is a snoop stall, meaning that at least one processor is not ready to deliver its snoop results. Memory read state 100 is also an illegal state, since the HITM signal must be asserted whenever a HITC signal is asserted to prevent the memory controller 34 from attempting to source data to the data bus at the same time as a processor. Memory read state 101 indicates that at least one processor has a clean copy of the requested data, and the processor with the highest priority will source the data. Again, the HITM assertion in this state is a false assertion to prevent a bus conflict with the memory controller 34. Memory read state 110 is an illegal state, since this would again cause a bus conflict with the memory controller 34. Finally, memory read state 111 is a snoop stall. The table also indicates that it is illegal to assert a HITC signal during a memory write transaction. As mentioned above, the sideband HITC signals enabling cache to cache copying of clean data affect only the memory read operations.

A memory read operation in the computer system 10 is illustrated in the flow chart of FIG. 3. First, data is requested 110 by a processor in the computer system 10. The HITM signal 40 is examined 112 to determine whether it is asserted. If the HITM signal 40 is not asserted, the memory controller 34 sources 114 the requested data to the data bus 38. The processor requesting the data then copies 116 data from the data bus 38. If the HITM 40 signal is asserted and at least one HITC signal is asserted 120, the highest priority processor having the requested data in clean form sources 126 the data to the data bus 38. The processor requesting the data then copies 116 the data from the data bus 38, and the memory controller 34 copies the clean data from the data bus 38 to the memory 32. If the HITM 40 signal is asserted and no HITC signals are asserted 120, the processor having the requested data in modified form sources 122 the data to the data bus 38. The processor requesting the data then copies 116 the data from the data bus 38, and the memory controller 34 copies 124 the modified data from the data bus 38 to the memory 32.

In a second preferred exemplary embodiment, HITC signals are included in the bus architecture rather than being added as sideband signals, and the HIT signal 42 is excluded. This allows the memory controller to avoid unnecessary implicit writebacks.

Referring now to FIG. 4, the computer system 210 in this exemplary embodiment includes four computer processors 212, 214, 216, and 220. Each of the processors 212-220 includes an internal memory cache 222, 224, 226, and 230. The computer system 210 also includes a memory controller 234 and associated external memory 232. The bus interconnecting these elements of the computer system 210 includes an address bus 236, data bus 238, shared “modified data present” (HITM) signal 240, and four unshared “clean data present” (HITC) signal conductors 244, 246, 250, and 252. The address bus 236, data bus 238, and HITM signal 240 are connected to each of the four processors 212-220 and to the memory controller 234. The HITC signal conductors 244-252 are connected to the memory controller 234 as well as to the processors 212-220 as needed.

As discussed above, the exemplary arbitration scheme shown herein does not require that each HITC signal conductor 244-253 be connected to all four processors 212-220. The first HITC signal conductor 244 is associated with the first processor 212 and is connected to the HITCO signal output 260 on the first processor 212 and to the memory controller 234. The second HITC signal conductor 246 is associated with the second processor 214 and is connected to the HITC0 signal output 270 on the second processor 214, the HITC1 signal input 262 on the first processor 212, and to the memory controller 234. The third HITC signal conductor 250 is associated with the third processor 216 and is connected to the HITC0 signal output 280 on the third processor 216, the HITC2 signal input 264 on the first processor 212, the HITC1 signal input 272 on the second processor 214, and to the memory controller 234. The fourth HITC signal conductor 252 is associated with the fourth processor 220 and is connected to the HITCO signal output 290 on the fourth processor 220, the HITC3 signal input 266 on the first processor 212, the HITC2 signal input 274 on the second processor 214, the HITC1 signal input 282 on the third processor 216, and to the memory controller 234. This leaves HITC1 signal input 292, HITC2 signal inputs 284 and 294, and HITC3 signal inputs 276, 286, and 296 unused on three of the processors 214-220.

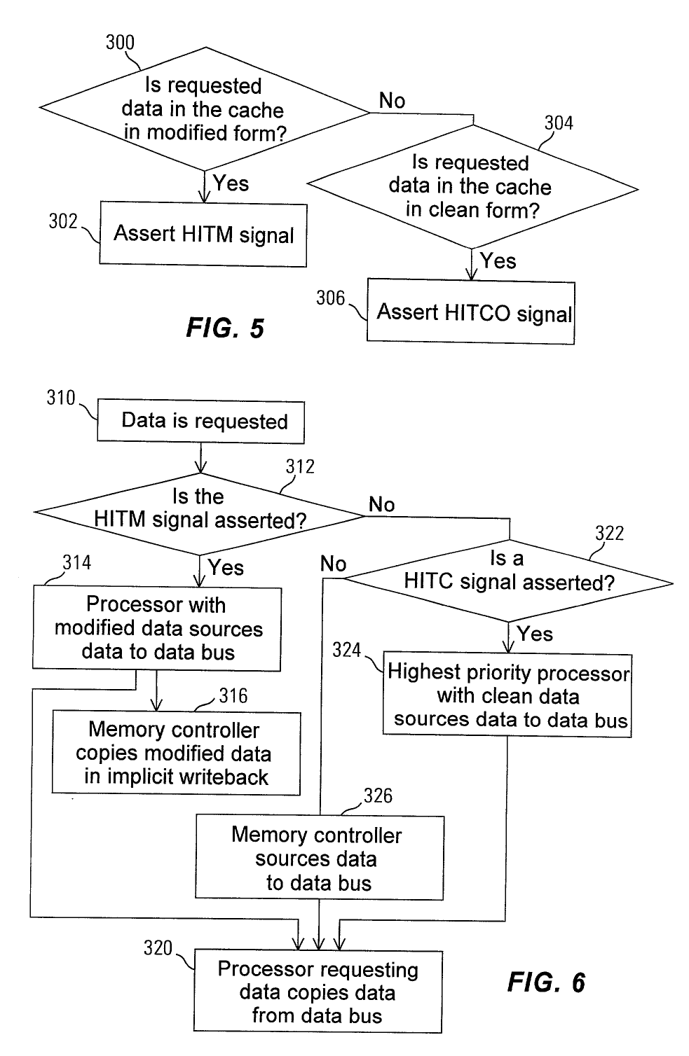

The HITM and HITC0 signal assertion process for this embodiment is illustrated in the flow chart of FIG. 5. When a device in the computer system 210 performs a read operation by placing an address on the address bus 236, each processor 212-220 snoops the address in its cache 222-230 and reports the results on the HITM and HITC signals 240 and 244-252. Thus, when each processor (e.g., 212 ) sees a request for data on the address bus 236, it examines 300 its cache 222 to determine whether the requested data is stored there in modified form. If so, the processor 212 asserts 302 the HITM 240 signal. If not, the processor 212 examines 304 its cache to determine whether the requested data is stored there in clean form. If the cache contains the clean data, the processor 12 asserts its HITC0 260 signal. This differs from the first exemplary embodiment in that no false HITM signal assertion is needed to prevent bus conflicts with the memory controller 234. Since the HITC signal conductors 244-252 are connected to the memory controller 234, it is aware that a processor will source clean requested data to the data bus 238. In other words, the memory controller 234 will only source requested data to the data bus 238 when the HITM signal 240 and HITC signal conductors 244-252 remain deasserted. The memory controller 234 will, as before, perform implicit writebacks when the HITM signal 240 is asserted, copying modified data into the memory 232.

The following snoop results table summarizes the effects on the computer system 210 of each possible snoop result.

| Transaction | | | |
|---|---|---|---|
| Snooped | HITCx | HITM | Result |
| Memory Read | 0 | 0 | Cache miss. |
| | | | Data sourced by the memory |
| | | | controller. |
| | 0 | 1 | Hit on a dirty line. |
| | | | Data sourced by the |
| | | | processor with the |
| | | | modified data. |
| | 1 | 0 | Hit on a clean line. |
| | | | Data sourced by the |
| | | | highest priority processor |
| | | | having the clean data. |
| | 1 | 1 | Snoop stall |
| Memory Write | 0 | X | Normal operation |
| | 1 | X | Illegal |
| Memory Read | 0 | 0 | Cache miss. |
| and | | | Data sourced by the memory |
| Invalidate | | | controller. |
| | 0 | 1 | Hit on a dirty line. |
| | | | Data sourced by the |
| | | | processor with the |
| | | | modified data. |
| | 1 | 0 | Hit on a clean line. |
| | | | Data sourced by the |
| | | | highest priority processor |
| | | | having the clean data. |
| | 1 | 1 | Snoop Stall |
| Invalidate | 0 | X | Normal operation |
| | 1 | X | Illegal |

A memory read operation in the computer system 210 is illustrated in the flow chart of FIG. 6. First, data is requested 310 by a processor in the computer system 210. If the HITM 240 signal is asserted 312, the processor having the requested data in modified from sources 314 the data to the data bus 238. The processor requesting the data then copies 320 the data from the data bus 238, and the memory controller 234 copies 316 the modified data from the data bus 238 to the memory 232. If the HITM signal 240 is not asserted 312 and at least one HITC signal is asserted 322, the highest priority processor having the requested data in clean form sources 324 the data to the data bus 238. The processor requesting the data then copies 320 the data from the data bus 238. If the HITM signal 240 and the HITC signals remain deasserted 312 and 322, the memory controller 234 sources 326 the requested data to the data bus 238. The processor requesting the data then copies 320 the data from the data bus 238.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A data storage apparatus, comprising:
a plurality of computer processors, each having an internal memory; and
a plurality of unshared “clean data present” indicators connected to said plurality of computer processors, each of said plurality of unshared “clean data present” indicators corresponding to one of said plurality of computer processors, wherein each of said plurality of computer processors is adapted to assert its corresponding unshared “clean data present” indicator when requested data is contained in its internal memory in an unmodified state.

2. The data storage apparatus of claim 1, wherein said requested data is in said unmodified state when a computer processor containing said requested data has not altered said data.

3. The data storage apparatus of claim 1, each of said plurality of unshared “clean data present” indicators being adapted to be asserted by only one of said plurality of computer processors.

4. The data storage apparatus of claim 1, further comprising an external memory connected to said plurality of computer processors.

5. The data storage apparatus of claim 4, wherein said plurality of unshared “clean data present” indicators are connected to said external memory.

6. The data storage apparatus of claim 4, further comprising a shared “modified data present” indicator connected to said plurality of computer processors.

7. The data storage apparatus of claim 6, wherein said shared “modified data present” indicator is connected to said external memory.

8. The data storage apparatus of claim 4, said shared “modified data present” indicator comprising an asserted state and an unasserted state, wherein said asserted state indicates that modified data is present.

9. The data storage apparatus of claim 4, said shared “modified data present” indicator being adapted to be asserted by any of said plurality of computer processors.

10. The data storage apparatus of claim 1, further comprising a shared “clean data present” indicator connected to said plurality of computer processors, wherein each of said plurality of computer processors is adapted to assert said shared “clean data present” indicator when requested data is contained in its internal memory in said unmodified state.

11. The data storage apparatus of claim 10, wherein said shared “clean data present” indicator is adapted to be asserted by any of said plurality of computer processors simultaneously.

12. The data storage apparatus of claim 10, wherein said shared “clean data present” indicator is connected to at least one external memory.

13. A method of sharing data in a computer system, comprising:
providing said computer system comprising:
a plurality of computer processors, each having an internal memory;
an external memory connected to said plurality of computer processors;
a plurality of unshared “clean data present” indicators connected to said plurality of computer processors, each of said plurality of unshared “clean data present” indicators corresponding to one of said plurality of computer processors;
a shared “modified data present” indicator connected to said plurality of computer processors and to said external memory;
a data bus connected to said plurality of computer processors and to said external memory; and
an address bus connected to said plurality of computer processors and to said external memory;
sharing data in said computer system according to signals placed on said plurality of unshared “clean data present” indicators, said shared “modified data present” indicator, and said address bus.

14. The method of claim 13, further comprising each of said plurality of computer processors asserting its corresponding one of said unshared “clean data present” indicators when requested data is contained in its internal memory in an unmodified state.

15. The method of claim 13, further comprising each of said plurality of computer processors asserting said shared “modified data present” indicator when requested data is contained in its internal memory in a modified state.

16. The method of claim 13, wherein said sharing data comprises:
said plurality of computer processors and said external memory monitoring said address bus for a data request; and
each of said plurality of computer processors and said external memory determining whether to transmit requested data on said data bus.

17. The method of claim 16, further comprising said external memory transmitting said requested data on said data bus after an address of said requested data appears on said address bus if said plurality of unshared “clean data present” indicators and said shared “modified data present” indicator are unasserted.

18. The method of claim 16, wherein said requested data is stored in said internal memory of one of said plurality of computer processors, and wherein said one of said plurality of computer processors has modified said requested data in said internal memory, the method further comprising said one of said plurality of computer processors transmitting said requested data on said data bus if said plurality of unshared “clean data present” indicators are unasserted and said shared “modified data present” indicator is asserted.

19. The method of claim 18, further comprising said external memory copying said requested data from said data bus.

20. The method of claim 16, wherein said requested data is stored in said internal memory of one of said plurality of computer processors, and wherein said one of said plurality of computer processors has not modified said requested data in said internal memory, and wherein one of said plurality of unshared “clean data present” indicators corresponding to said one of said plurality of computer processors is asserted, the method further comprising said one of said plurality of computer processors transmitting said requested data on said data bus after an address of said requested data appears on said address bus.

21. The method of claim 20, wherein said requested data is stored in said internal memory of at least two of said plurality of computer processors, and wherein at least two of said plurality of unshared “clean data present” indicators are asserted, the method further comprising said at least two of said plurality of computer processors determining whether to transmit said requested data on said data bus by examining said at least two of plurality of unshared “clean data present” indicators which are asserted to determine which of said at least two of said plurality of computer processors has the highest priority.

22. The method of claim 21, wherein said plurality of unshared “clean data present” indicators are prioritized, and wherein said plurality of computer processors are prioritized, and wherein said examining said at least two of plurality of unshared “clean data present” indicators which are asserted to determine which of said at least two of said plurality of computer processors has the highest priority comprises each of said at least two of said plurality of computer processors comparing its priority with a highest priority of said at least two of plurality of unshared “clean data present” indicators which are asserted so that the highest priority computer processor asserting its unshared “clean data present” indicator transmits said requested data on said data bus.

23. The method of claim 13, wherein said computer system further comprises a shared “clean data present” indicator connected to said plurality of computer processors and to said external memory, further comprising each of said plurality of computer processors asserting said shared “clean data present” indicator when requested data is contained in its internal memory in an unmodified state.

24. The method of claim 23, further comprising each of said plurality of computer processors asserting its corresponding unshared “clean data present” indicator and said shared “modified data present” indicator when requested data is contained in its internal memory in an unmodified state.

25. The method of claim 24, further comprising said external memory copying said requested data from said data bus when said shared “modified data present” indicator and at least one of said plurality of unshared “clean data present” indicators are asserted.

26. A method of operating a computer system comprising:
placing a plurality of signals on unshared “clean data present” indicators associated with a plurality of computer processors in said computer system; and
placing data on a data bus in said computer system based upon said plurality of signals.

27. A computer system, comprising:
a plurality of computer processors, each having an internal cache memory;
an external memory connected to said plurality of computer processors; and
unshared “clean data present” indicator means connected to said plurality of computer processors.
